(19) United States
(12) Patent Application Publication
(10) Pub. No.: US 2020/0254738 A1
(43) Pub. Date: Aug. 13, 2020

(54) LAMINATE

(71) Applicant: TOYOTA JIDOSHA KABUSHIKI KAISHA, Toyota-shi (JP)

(72) Inventors: Masato ONO, Sunto-gun (JP); Norihiro OSE, Sunto-gun (JP); Kazuhito KATO, Sunto-gun (JP)

(21) Appl. No.: 16/782,218

(22) Filed: Feb. 5, 2020

(30) Foreign Application Priority Data
Feb. 12, 2019 (JP) 2019-022543

(51) Int. Cl. B32B 27/08; B32B 7/12

(52) U.S. Cl. CPC B32B 27/08; C09J 7/38; B32B 2457/10; B32B 7/12

(57) ABSTRACT

Provided is a laminate which is configured to suppress the cracking of the current collector and the active material layer at the time of peeling them off from each other, and which is configured to make it easy to recycle and repair them. Disclosed is a laminate comprising a current collector, an active material layer and an electrolyte layer in this order, wherein the current collector and the active material layer adhere to each other in a peelable manner, through a pressure-sensitive adhesive that shows plasticity at normal temperature (15° C. to 25° C.)

### RELATED APPLICATION

This application claims priority to Japanese Patent Application No. 2019-022543, filed on Feb. 12, 2019, including the specification, drawings and abstract, the entire disclosure of which is incorporated herein by reference.

### TECHNICAL FIELD

The disclosure relates to a laminate.

### BACKGROUND

In recent years, with the rapid spread of IT and communication devices such as personal computers, camcorders and cellular phones, great importance has been attached to the development of batteries that is usable as the power source of such devices. In the automobile industry, etc., high-power and high-capacity batteries for electric vehicles and hybrid vehicles are under development.

In the field of batteries such as a lithium ion battery, an all-solid-state battery in which, as an electrolyte present between a cathode active material layer and an anode active material layer, a solid electrolyte is used in place of an electrolytic solution containing an organic solvent, is under development. Since a combustible organic solvent is not used in the all-solid-state battery, the all-solid-state battery is considered to enable the simplification of safety devices, reduce production costs and provide excellent productivity. Since the all-solid-state battery becomes conductive by physical contact between the layers, the layers are disposed to be in contact with each other.

Patent Literature 1 discloses a laminate suitably fixed by attaching a cathode foil and a cathode active material layer with a thermoplastic resin.

Patent Literature 2 discloses that a conducting adhesive layer is disposed between a cathode active material layer and a separator.

Patent Literature 1: Japanese Patent Application Laid-Open (JP-A) No. 2017-204377

Patent Literature 2: JP-A No. 2017-216160

When a current collector and an active material layer are attached with a thermoplastic resin, there is the following problem: the current collector and the active material layer may be cracked at the time of peeling them off from each other, and it is difficult to recycle and repair them.

### SUMMARY

In light of the above circumstances, an object of the disclosed embodiments is to provide a laminate comprising a current collector and an active material layer, which is configured to suppress the cracking of the current collector and the active material layer at the time of peeling them off from each other, and which is configured to make it easy to recycle and repair them.

In a first embodiment, there is provided a laminate comprising a current collector, an active material layer and an electrolyte layer in this order, wherein the current collector and the active material layer adhere to each other in a peelable manner, through a pressure-sensitive adhesive that shows plasticity at normal temperature (15° C. to 25° C.)

According to the disclosed embodiments, the laminate which is configured to suppress the cracking of the current collector and the active material layer at the time of peeling them off from each other, and which is configured to make it easy to recycle and repair them.

### BRIEF DESCRIPTION OF THE DRAWINGS

In the accompanying drawings,

FIG. 1 is a schematic sectional view of an example of the laminate of the disclosed embodiments;

FIG. 2 is a schematic sectional view of an example of the battery unit of the all-solid-state battery of the disclosed embodiments; and

FIG. 3 is a schematic sectional view of an example of the battery unit laminate of the all-solid-state battery of the disclosed embodiments.

### DETAILED DESCRIPTION

The laminate of the disclosed embodiments is a laminate comprising a current collector, an active material layer and an electrolyte layer in this order,

wherein the current collector and the active material layer adhere to each other in a peelable manner, through a pressure-sensitive adhesive that shows plasticity at normal temperature (15° C. to 25° C.)

In the disclosed embodiments, the pressure-sensitive adhesive (adhesive) that shows plasticity at normal temperature, is used in place of an adhesive that is curable at normal temperature. Accordingly, the laminate in which the current collector and the active material layer can be easily peeled off from each other and have excellent recycling efficiency and repairability, is provided.

According to the disclosed embodiments, in the case of producing a battery unit laminate comprising battery units, even if a defect (such as short circuits) occurs in some of the battery units, it is not necessary to discard all of the battery units. Instead, only the battery units causing the defect can be easily separated from the laminate, discarded, and replaced with new non-defective battery units. Accordingly, the battery unit laminate is large in yield, and the production cost of the battery unit laminate is reduced.

FIG. 1 is a schematic sectional view of an example of the laminate of the disclosed embodiments.

A laminate 100 of the disclosed embodiments comprises a current collector 10, an active material layer 11 and an electrolyte layer 12 in this order.

In the laminate 100 of the disclosed embodiments, the current collector 10 and the active material layer 11 adhere to each other in a peelable manner, through a pressure-sensitive adhesive 13 that shows plasticity at normal temperature (15° C. to 25° C.)

The pressure-sensitive adhesive is not particularly limited, as long as it is a pressure-sensitive adhesive that shows plasticity at normal temperature (15° C. to 25° C.)

For the viscosity of the pressure-sensitive adhesive at normal temperature, the upper limit may be 500000 CP (≈500 Pa·s) or less, from the viewpoint of easily peeling off the current collector and the active material layer from each other. On the other hand, the lower limit may be 100000 CP (≈100 Pa·s) or more, from the viewpoint of further increasing the adhesion between the current collector and the active material layer.

For the adhesive shear force of the pressure-sensitive adhesive between the current collector and the active material layer, the lower limit may be 0.004 N/mm² or more, from the viewpoint of further increasing the adhesion between the current collector and the active material layer. On the other hand, the upper limit may be 0.2 N/mm² or less, from the viewpoint of easily peeling off the current collector and the active material layer from each other.

The adhesive shear force can be measured by the following method.

First, a rectangular active material layer having, when viewed from above, a shorter side length of 15 mm and a longer side length of more than 15 mm, and a rectangular current collecting foil having, when viewed from above, a shorter side length of 15 mm and a longer side length of more than 15 mm, are prepared. The thickness of the active material layer and that of the current collecting foil are not particularly limited and may be the same or different.

Next, the pressure-sensitive adhesive is applied to a first region on one end part of the current collecting foil, which is a region having, when viewed from above, a shorter side length of 15 mm and a longer side length of 15 mm, to ensure that the size of the applied pressure-sensitive adhesive is as follows: 15 mm (shorter side length)×15 mm (longer side length)×5 μm (thickness).

Next, a second region on one end part of the active material layer, which is a region having, when viewed from above, a shorter side length of 15 mm and a longer side length of 15 mm, is disposed on the first region on one end part of the current collecting foil to ensure that, when viewed from above, the second region is overlaid on the first region formed by applying the pressure-sensitive adhesive on the current collecting foil, and the active material layer and the current collecting foil are aligned in a line.

Next, the active material layer and the current collecting foil are pressed at 5 MPa to allow the second region on one end part of the active material layer to adhere to the first region on one end part of the current collecting foil through the pressure-sensitive adhesive, thereby producing an adhesive shear force measurement sample comprising the active material layer and the current collecting foil.

Then, adhesive shear force evaluation of the sample is carried out as follows. First, the other end part of the active material layer, which, when viewed from above, does not adhere to the current collecting foil, is grasped. In addition, the other end part of the current collecting foil, which does not adhere to the active material layer, is grasped. Next, the current collecting foil and the active material layer are pulled in plane direction and in both directions, at a rate of 100 mm/min, and the strength at the time when the active material layer and the current collecting foil are peeled off from each other or at the time when the active material layer and the current collecting foil are ruptured, is measured.

As the pressure-sensitive adhesive, examples include, but are not limited to, a pressure-sensitive adhesive containing at least an adhesive resin and, as needed, an electroconductive substance, etc.

As the adhesive resin, examples include, but are not limited to, silicone resin and acrylic resin.

As the electroconductive substance that may be contained in the pressure-sensitive adhesive, examples include, but are not limited to, powders such as carbon powder and aluminum powder. When the pressure-sensitive adhesive is present in the whole region where the current collector and active material layer adhering to each other are overlaid on each other, the pressure-sensitive adhesive may be the pressure-sensitive adhesive containing the electroconductive substance, from the viewpoint of better conduction between the current collector and the active material layer.

For the pressure-sensitive adhesive containing the electroconductive substance, the content of the electroconductive substance is not particularly limited. From the viewpoint of better conduction between the current collector and the active material layer and from the viewpoint of suppressing an increase in battery resistance, the content of the electroconductive substance may be controlled to ensure that the volume resistivity of the pressure-sensitive adhesive is 10×10³ Ω/cm or less.

When the electroconductive substance is carbon powder, the content of the carbon powder contained in the pressure-sensitive adhesive is from 1 mass % to 10 mass %, when the total mass of the pressure-sensitive adhesive is determined as 100 mass %.

The thickness of the pressure-sensitive adhesive in the laminating direction of the laminate, is not particularly limited. For example, it may be 0.1 μm or more and 10 μm or less.

The position to dispose the pressure-sensitive adhesive is not particularly limited, as long as the pressure-sensitive adhesive is disposed on at least a part of one surface of the active material layer in the region where the active material layer and the current collector face each other and are overlaid on each other, and on at least a part of one surface of the current collector in the same region. When the active material layer and the current collector are in a rectangular form, from the viewpoint of better balance between peelability and adhesion, the pressure-sensitive adhesive may be disposed at predetermined four corners of the region where the active material layer and the current collector face each other and are overlaid on each other.

The method for disposing the pressure-sensitive adhesive is not particularly limited. The pressure-sensitive adhesive may be disposed by application.

The amount of the pressure-sensitive adhesive applied to the current collector is not particularly limited. For example, the pressure-sensitive adhesive may be applied as follows: the pressure-sensitive adhesive is formed into balls having a diameter of about 1 mm, and the pressure-sensitive adhesive balls are applied on the predetermined four corners of the region where the active material layer and the current collector face each other and are overlaid on each other, and predetermined pressure is applied thereto until the thickness of the pressure-sensitive adhesive balls reaches a predetermined thickness.

More specifically, from the viewpoint of handling, the pressure-sensitive adhesive may be such a pressure-sensitive adhesive, that at normal temperature, the balls of the pressure-sensitive adhesive (ball diameter: 1 mm) can be pressed to a thickness of from 0.1 μm to 10 μm, by pressing at a pressure of 1 MPa or more and 20 MPa or less. The pressure of 20 MPa is a value corresponding to the confining pressure of a battery.

### [Active Material Layer]

The active material layer of the laminate may be a cathode active material layer or an anode active material layer.

When the active material layer of the laminate is a cathode active material layer, the current collector is a cathode current collector. When the active material layer of the laminate is an anode active material layer, the current collector is an anode current collector.

### [Cathode Active Material Layer]

The cathode active material layer contains a cathode active material. As optional components, the cathode active material layer may contain a solid electrolyte, an electroconductive material, a binder, etc.

As the cathode active material, examples include, but are not limited to, a cathode active material represented by the following general formula: LiₓM_{y}O_{z} (where M is a transition metal element; x is from 0.02 to 2.2; y is from 1 to 2; and z is from 1.4 to 4). The transition metal element M may be at least one selected from the group consisting of Co, Mn, Ni, V, Fe and Si, or it may be at least one selected from the group consisting of Co, Ni and Mn. As the cathode active material represented by the general formula LiₓM_{y}O_{z}, examples include, but are not limited to, LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, Li₂FeSiO₄ and Li₂MnSiO₄.

Cathode active materials other than the one represented by the general formula LiₓM_{y}O_{z} include, for example, lithium titivates (such as Li₄Ti₅O₁₂), lithium metal phosphates (such as LiFePO₄, LiMnPO₄, LiCoPO₄ and LiNiPO₄), transition metal oxides (such as V₂O₅ and MoO₃), TiS₂, LiCoN, Si, SiO₂, Li₂SiO₃, Li₄SiO₄, and lithium storage intermetallic compounds (such as Mg₂Sn, Mg₂Ge, Mg₂Sb and Cu₃Sb).

The form of the cathode active material is not particularly limited. It may be a particulate form.

A coat layer containing a Li ion conducting oxide may be formed on the surface of the cathode active material. This is because a reaction between the cathode active material and the solid electrolyte can be suppressed.

As the Li ion conducting oxide, examples include, but are not limited to, LiNbO₃, Li₄Ti₅O₁₂ and Li₃PO₄.

The content of the cathode active material in the cathode active material layer is not particularly limited. For example, it may be in a range of from 10 mass % to 100 mass %.

As the solid electrolyte used in the cathode active material layer, examples include, but are not limited to, those exemplified below as the solid electrolyte used in the below-described electrolyte layer. The content of the solid electrolyte in the cathode active material layer is not particularly limited.

As the electroconductive material, a known electroconductive material may be used. As the electroconductive material, examples include, but are not limited to, a carbonaceous material and metal particles. For example, the carbonaceous material may be at least one selected from the group consisting of carbon nanotube, carbon nanofiber and carbon black such as acetylene black or furnace black. Of them, from the viewpoint of electron conductivity, the electroconductive material may be at least one selected from the group consisting of carbon nanotube and carbon nanofiber. The carbon nanotube and the carbon nanofiber may be vapor-grown carbon fiber (VGCF). As the metal particles, examples include, but are not limited to, particles of Al, particles of Ni, particles of Cu, particles of Fe and particles of SUS. The content of the electroconductive material in the cathode active material layer is not particularly limited.

As the binder, examples include, but are not limited to, rubber-based binders such as butadiene rubber, hydrogenated butadiene rubber, styrene-butadiene rubber (SBR), hydrogenated styrene-butadiene rubber, nitrile-butadiene rubber, hydrogenated nitrile-butadiene rubber and ethylene-propylene rubber; fluoride-based binders such as polyvinylidene fluoride (PVdF), polyvinylidene fluoride-polyhexafluoropropylene copolymer (PVDF-HFP), polytetrafluoroethylene and fluorine rubber; polyolefin-based thermoplastic resins such as polyethylene, polypropylene and polystyrene; imide-based resins such as polyimide and polyamideimide; amide-based resins such as polyamide; acrylic resins such as polymethyl acrylate and polyethyl acrylate; and methacrylic resins such as polymethyl methacrylate and polyethyl methacrylate. The content of the binder in the cathode active material layer is not particularly limited.

The thickness of the cathode active material layer is not particularly limited. For example, it may be 0.1 μm or more and 1000 μm or less.

### [Cathode Current Collector]

As the cathode current collector, a conventionally-known metal material that is usable as a current collector in all-solid-state batteries, may be used. As the metal material, examples include, but are not limited to, SUS, Cu, Ni, Al, V, Au, Pt, Mg, Fe, Ti, Co, Cr, Zn, Ge and In.

The form of the cathode current collector is not particularly limited. As the form, examples include, but are not limited to, various kinds of forms such as a foil form and a mesh form.

The cathode current collector may include a cathode lead to be connected with an external terminal.

The cathode current collector may be such a metal foil, that the above-described metal is contained therein and at least a part of the surface is coated with a coat layer containing an electroconductive material such as Ni, Cr or C (carbon). Due to the presence of the coat layer, the formation of a passivated coating film on the cathode current collector and the resulting increase in the internal resistance of the all-solid-state battery, are suppressed.

The coat layer contains as least the electroconductive material. As needed, it may further contain other components such as a binder. As the binder that may be contained in the coat layer, examples include, but are not limited to, those mentioned above as the binder that may be contained in the above-described cathode active material layer. The coat layer may be a plating or deposition layer composed of the electroconductive material.

As the coat layer, examples include, but are not limited to, a carbon coat layer in which 15 mass % of carbon (C) is contained as the electroconductive material, in which 85 mass % of polyvinylidene fluoride (PVDF) is contained as the binder, and which has a volume resistivity of from 1×10³ Ωcm to 10×10³ Ωcm or a volume resistivity of 5×10³ Ωcm.

The thickness of the coat layer is not particularly limited. For example, the thickness may be about 10 μm.

From the viewpoint of easily suppressing an increase in the internal resistance of a battery, the coat layer may be disposed in the region where, on the cathode current collector, the cathode current collector and cathode active material layer adhering to each other are overlaid on each other. When the cathode current collector and cathode active material layer adhering to each other have a part where they are in direct contact with each other without the pressure-sensitive adhesive, at least a part of the surface of the cathode current collector being in direct contact with the cathode active material layer, may be coated with the coat layer.

### [Anode Active Material Layer]

The anode active material layer contains an anode active material. As optional components, the anode active material layer may contain a solid electrolyte, an electroconductive material, a binder, etc.

As the anode active material, a conventionally-known material may be used. As the conventionally-known material, examples include, but are not limited to, elemental Li, a lithium alloy, carbon, elemental Si, a Si alloy and Li₄Ti₅O₁₂ (LTO).

As the lithium alloy, examples include, but are not limited to, LiSn, LiSi, LiAl, LiGe, LiSb, LiP and LiIn.

As the Si alloy, examples include, but are not limited to, alloys with metals such as Li. Also, the Si alloy may be an alloy with at least one kind of metal selected from the group consisting of Sn, Ge and Al.

The form of the anode active material is not particularly limited. For example, the anode active material may be in a particulate form or a thin film form.

When the anode active material is in a particulate form, the average particle diameter (D₅₀) of the anode active material particles may be 1 nm or more and 100 μm or less, or it may be 10 nm or more and 30 μm or less, for example.

As the electroconductive material, binder and solid electrolyte contained in the anode active material layer, examples include, but are not limited to, those exemplified above as the electroconductive material, binder and solid electrolyte contained in the above-described cathode active material layer.

### [Anode Current Collector]

As the anode current collector, examples include, but are not limited to, those exemplified above as the metal materials that may be used as the cathode current collector.

The form of the anode current collector is not particularly limited. It may be the same form as the above-described cathode current collector.

The anode current collector may include an anode lead to be connected with an external terminal.

### [Electrolyte Layer]

The electrolyte layer may be a separator layer obtained by impregnating a separator with liquid electrolyte, or it may be a solid electrolyte layer containing a solid electrolyte. From the viewpoint of imparting excellent recycling efficiency and repairability to the current collector and the active material layer, the electrolyte layer may be a solid electrolyte layer. As the separator, examples include, but are not limited to, a non-woven fabric and a porous film.

The solid electrolyte layer contains at least a solid electrolyte.

As the solid electrolyte, examples include, but are not limited to, a sulfide-based solid electrolyte and an oxide-based solid electrolyte.

As the sulfide-based solid electrolyte, examples include, but are not limited to, Li₂S-P₂S₅, Li₂S-SiS₂, LiX-Li₂S-SiS₂, LiX-Li₂S-P₂S₅, LiX-Li₂O-Li₂S-P₂S₅, LiX-Li₂S-P₂O₅, LiX-Li₃PO₄-P₂S₅ and Li₃PS₄. The “Li₂S-P₂S₅” means a material composed of a raw material composition containing Li₂S and P₂S₅, and the same applies to other solid electrolytes. Also, “X” in the “LiX” means a halogen element. The LiX contained in the raw material composition may be one or more kinds. When two or more kinds of LiX are contained in the raw material composition, the mixing ratio is not particularly limited.

For example, the sulfide-based solid electrolyte may be a sulfide-based solid electrolyte produced by mixing Li₂S and P₂S₅ to ensure that the mass ratio between Li₂S and P₂S₅ (Li₂S/P₂S₅) is 0.5 or more. From the viewpoint of ion conductivity, the sulfide-based solid electrolyte may be a sulfide-based solid electrolyte obtained by mixing Li₂S and P₂S₅ to ensure that the mass ratio of Li₂S to P₂S₅ is 70:30.

The molar ratio of the elements in the sulfide-based solid electrolyte can be controlled by controlling the contents of the elements contained in raw materials. The molar ratio and composition of the elements in the sulfide-based solid electrolyte can be measured by inductively coupled plasma atomic emission spectroscopy, for example.

The sulfide-based solid electrolyte may be sulfide glass, crystallized sulfide glass (glass ceramics) or a crystalline material obtained by developing a solid state reaction of the raw material composition.

The crystal state of the sulfide-based solid electrolyte can be confirmed by X-ray powder diffraction measurement using CuKα radiation, for example.

The sulfide glass can be obtained by amorphizing a raw material composition (such as a mixture of Li₂S and P₂S₅). The raw material composition can be amorphized by mechanical milling, for example. The mechanical milling may be dry mechanical milling or wet mechanical milling. The mechanical milling may be the latter because attachment of the raw material composition to the inner surface of a container, etc., can be prevented.

The mechanical milling is not particularly limited, as long as it is a method for mixing the raw material composition by applying mechanical energy thereto. The mechanical milling may be carried out by, for example, a ball mill, a vibrating mill, a turbo mill, mechanofusion, or a disk mill. The mechanical milling may be carried out by a ball mill, or it may be carried out by a planetary ball mill. This is because the desired sulfide glass can be efficiently obtained.

The glass ceramics can be obtained by heating the sulfide glass, for example.

For the heating, the heating temperature may be a temperature higher than the crystallization temperature (Tc) of the sulfide glass, which is a temperature observed by thermal analysis measurement. In general, it is 195° C. or more. On the other hand, the upper limit of the heating temperature is not particularly limited.

The crystallization temperature (Tc) of the sulfide glass can be measured by differential thermal analysis (DTA).

The heating time is not particularly limited, as long as the desired crystallinity of the glass ceramics is obtained. For example, it is in a range of from one minute to 24 hours, or it may be in a range of from one minute to 10 hours.

The heating method is not particularly limited. For example, a firing furnace may be used.

As the oxide-based solid electrolyte, examples include, but are not limited to, Li_{6.25}La₃Zr₂Al_{0.25}O₁₂, Li₃PO₄, and Li₃₋ₓPO₄₋ₓNₓ (LiPON).

From the viewpoint of handling, the form of the solid electrolyte may be a particulate form.

The average particle diameter (D₅₀) of the solid electrolyte particles is not particularly limited. The lower limit may be 0.5 μm or more, and the upper limit may be 2 μm or less.

As the solid electrolyte, one or more kinds of solid electrolytes may be used. In the case of using two or more kinds of solid electrolytes, they may be mixed together.

In the disclosed embodiments, unless otherwise noted, the average particle diameter of particles is a volume-based median diameter (D₅₀) measured by laser diffraction/scattering particle size distribution measurement. Also in the disclosed embodiments, the median diameter (D₅₀) of particles is a diameter at which, when particles are arranged in ascending order of their particle diameter, the accumulated volume of the particles is half (50%) the total volume of the particles (volume average diameter).

The content of the solid electrolyte in the solid electrolyte layer is not particularly limited.

From the viewpoint of exerting plasticity, etc., a binder for binding the solid electrolyte particles can be incorporated in the solid electrolyte layer. As the binder, examples include, but are not limited to, those exemplified above as the binder that can be incorporated in the above-described cathode active material layer. However, the content of the binder in the solid electrolyte layer may be 5.0 mass % or less, from the viewpoint of, for the purpose of easily achieving high battery power output, preventing excessive aggregation of the solid electrolyte particles, enabling the formation of the solid electrolyte layer in which the solid electrolyte particles are uniformly dispersed, etc.

The thickness of the solid electrolyte layer is not particularly limited and is appropriately controlled depending on battery structure. It is generally 0.1 μm or more and 1 mm or less.

The solid electrolyte layer may be formed by pressure-forming a powdered material for forming the solid electrolyte layer, the material containing the solid electrolyte and, as needed, other components, for example.

### [Laminate Production Method]

The laminate production method of the disclosed embodiments is not particularly limited, as long as it is a method by which the above-described laminate of the disclosed embodiments is obtained.

The laminate production method of the disclosed embodiments comprises, for example, (1) a stacking step, (2) a pressing step and (3) a pressure-sensitive adhesive disposing step.

### (1) Stacking Step

The stacking step is a step of obtaining an assembly by preparing at least the active material layer and the electrolyte layer and stacking them.

The method for stacking the active material layer and the electrolyte layer is not particularly limited. For example, the active material layer and the electrolyte layer may be stacked by forming the active material layer on a support and then forming the electrolyte layer thereon. Another method for stacking the active material layer and the electrolyte layer may be as follows: first, the active material layer and the electrolyte layer are formed on different supports, and the electrolyte layer is transferred on the active material layer, thereby stacking the active material layer and the electrolyte layer. At the time of transferring the active material layer, pressure is applied. The pressure is not particularly limited, and it may be about 100 MPa.

The assembly may be an assembly obtained by stacking at least the active material layer and the electrolyte layer. Depending on the intended use, the assembly may be an assembly in which the cathode active material layer, the electrolyte layer and the anode active material layer are disposed in this order.

The method for forming the active material layer is not particularly limited. For example, the active material layer may be formed by pressure-forming a powdered electrode mixture containing an active material and, as needed, other components.

Another example of the method for forming the active material layer may be as follows: an electrode mixture paste containing an active material, a solvent and, as needed, other components is prepared; the electrode mixture paste is applied on one surface of a support such as the solid electrolyte layer; and the applied electrode mixture paste is dried, thereby forming the active material layer.

As the solvent used in the electrode mixture paste, examples include, but are not limited to, butyl acetate, heptane and N-methyl-2-pyrrolidone.

The method for applying the electrode mixture paste on one surface of the support such as the solid electrolyte layer, is not particularly limited. As the method, examples include, but are not limited to, a doctor blade method, a metal mask printing method, an electrostatic coating method, a dip coating method, a spray coating method, a roller coating method, a gravure coating method and a screen printing method.

### (2) Pressing Step

The pressing step is a step of pressing the assembly at a given pressure in the laminating direction of the assembly.

The pressure applied to press the assembly may be more than 20 MPa and 600 MPa or less, for example.

The temperature of the pressing step is not particularly limited. It may be appropriately controlled to a temperature that is less than the deterioration temperatures of the materials contained in the assembly.

The method for pressing the assembly is not particularly limited. As the method, examples include, but are not limited to, pressing by use of a plate press machine, a roll press machine or the like.

### (3) Pressure-Sensitive Adhesive Disposing Step

The pressure-sensitive adhesive disposing step is a step of obtaining the laminate by (a) preparing the current collector, (b) disposing the pressure-sensitive adhesive on at least one surface of the current collector or on the surface opposite to the electrolyte layer-side surface of the active material layer of the assembly, and (c) allowing the current collector and the active material layer to adhere to each other through the pressure-sensitive adhesive. The laminate becomes a part or all of the layer structure of the battery. As long as the laminate comprises at least the current collector, the active material layer and the electrolyte layer, the layer structure may be appropriately changed depending on the intended use, and the laminate may be the below-described battery unit or battery unit laminate.

In the pressure-sensitive adhesive disposing step, for example, a first laminate comprising a first current collector, a first active material layer, a first electrolyte layer and a second active material layer in this order, may be obtained by disposing the pressure-sensitive adhesive on one surface of the current collector and allowing the active material layer of the assembly to adhere to the one surface of the current collector.

As needed, a second current collector may further adhere to the surface opposite to the first electrolyte layer-side surface of the second active material layer through the pressure-sensitive adhesive, thereby obtaining a battery unit.

In addition, a second laminate comprising a third active material layer, a second electrolyte layer, a fourth active material layer and a third current collector in this order and having the same layer structure as the first laminate, may be prepared, and the third active material layer of the second laminate may adhere to the surface opposite to the second active material layer-side surface of the second current collector through the pressure-sensitive adhesive, thereby obtaining a battery unit laminate.

In this case, when the first active material layer is the cathode active material layer, the second active material layer may be the anode active material layer, and the third active material layer may be the cathode active material layer or the anode active material layer. When the third active material layer is the cathode active material layer, the fourth active material layer is the anode active material layer.

Also in the pressure-sensitive adhesive disposing step, a third laminate comprising the first active material layer, the first electrolyte layer, the second active material layer, the first current collector, the third active material layer, the second electrolyte layer and the fourth active material layer in this order, may be obtained by disposing the pressure-sensitive adhesive on both surfaces of the current collector and allowing the active material layers of the assemblies to adhere to both surfaces of the current collector.

Next, the second current collector may further adhere to the surface opposite to the first electrolyte layer-side surface of the first active material layer through the pressure-sensitive adhesive, thereby obtaining a battery unit, or the third current collector may further adhere to the surface opposite to the second electrolyte layer-side surface of the fourth active material layer through the pressure-sensitive adhesive, thereby obtaining a battery unit.

In addition, a fourth laminate having the same layer structure as the third laminate may be prepared, and the fifth active material layer of the fourth laminate may adhere to the surface opposite to the first active material layer-side surface of the second current collector through the pressure-sensitive adhesive, thereby obtaining a battery unit laminate.

In this case, when the first and fourth active material layers are the cathode active material layers, the second and third active material layers may be the anode active material layers, and the fifth active material layer may be the cathode active material layer or the anode active material layer.

The pressure-sensitive adhesive disposing step may be carried out after the abode-described pressing step, from the viewpoint of allowing the current collector and the active material layer to be in a peelable state.

In the pressure-sensitive adhesive disposing step, the pressure-sensitive adhesive may be disposed on at least one surface of the current collector or on the surface opposite to the electrolyte layer-side surface of the active material layer of the assembly by, for example, applying the pressure-sensitive adhesive, which is in a paste form, on the surface, or by attaching the pressure-sensitive adhesive, which is in a film or sheet form, to the surface. As the pressure-sensitive adhesive in the film or sheet form, examples include, but are not limited to, a double-sided adhesive tape.

From the viewpoint of easily reducing the thickness of the pressure-sensitive adhesive and easily applying uniform pressure at the time of pressing, the disposed pressure-sensitive adhesive may be the pressure-sensitive adhesive in the paste form.

At the time of disposing the pressure-sensitive adhesive on the current collector or the active material layer, the pressure-sensitive adhesive may be disposed to ensure that at least a part of the current collector and active material layer in the region where the current collector and the active material layer are overlaid on each other and adhere to each other, that is, at least a part of the current collector and active material layer overlaid on each other, adhere to each other.

Pressure is applied to allow the current collector and the active material layer to adhere to each other. From the viewpoint of keeping the peelability and suppressing the cracking of the active material layer and the current collector, the pressure may be lower than the press pressure applied in the above-described pressing step, and it may be from 1 MPa to 20 MPa.

The current collector and active material layer of the laminate thus obtained, can be peeled off from each other. Accordingly, for the thus-obtained battery unit laminate, the battery units are detachable from each other, and each battery unit can be recycled and repaired. Accordingly, it is easy to recycle and repair the battery unit laminate.

### [All-Solid-State Battery]

The laminate of the disclosed embodiments may be used as a part or all of the layer structure of various kinds of batteries.

The laminate of the disclosed embodiments may have a layer structure that functions as an all-solid-state battery, from the viewpoint of easily recycling and repairing the battery unit.

The all-solid-state battery of the disclosed embodiment may comprise one or more battery units each comprising a cathode comprising a cathode active material layer and a cathode current collector, an anode comprising an anode active material layer and an anode current collector, and a solid electrolyte layer disposed between the cathode active material layer and the anode active material layer, or the all-solid-state battery of the disclosed embodiment may be the battery unit laminate comprising a plurality of the battery units.

For the battery unit of the disclosed embodiments, the current collector and active material layer of at least one of the cathode and the anode may adhere to each other in a peelable manner through the pressure-sensitive adhesive. From the viewpoint of easily recycling and repairing the battery unit, the cathode active material layer and the cathode current collector may adhere to each other in a peelable manner through the pressure-sensitive adhesive, and the anode active material layer and the anode current collector may adhere to each other in a peelable manner through the pressure-sensitive adhesive.

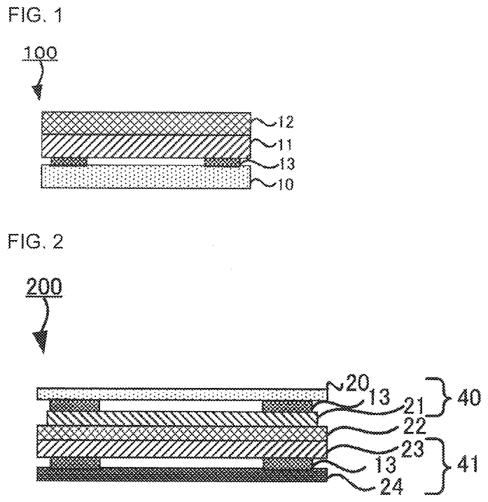

FIG. 2 is a schematic sectional view of an example of the battery unit of the all-solid-state battery of the disclosed embodiments.

As shown in FIG. 2, a battery unit 200 comprises a cathode 40 comprising a cathode current collector 20 and a cathode active material layer 21, an anode 41 comprising an anode current collector 24 and an anode active material layer 23, and a solid electrolyte layer 22 disposed between the cathode active material layer 21 and the anode active material layer 23. The cathode active material layer 21 adheres to the cathode current collector 20 through a pressure-sensitive adhesive 13, and the anode active material layer 23 adheres to the anode current collector 24 through the pressure-sensitive adhesive 13.

### [Battery Unit Laminate]

For the battery unit laminate of the disclosed embodiments, the cracking of the current collector and the active material layer can be suppressed at the time of peeling them off from each other, and it is easy to recycle and repair the battery unit laminate.

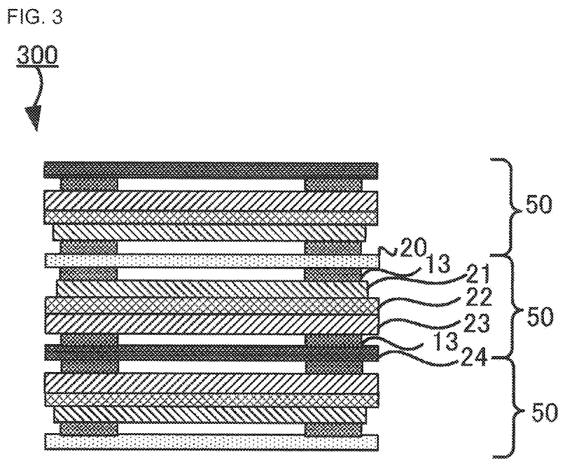

FIG. 3 is a schematic sectional view of an example of the battery unit laminate of the all-solid-state battery of the disclosed embodiments.

A battery unit laminate 300 shown in FIG. 3 comprises three battery units 50 each comprising a cathode current collector 20, a cathode active material layer 21, a solid electrolyte layer 22, an anode active material layer 23, an anode current collector 24, an anode active material layer 23, a solid electrolyte layer 22 and a cathode active material layer 21 in this order. Each cathode active material layer 21 adheres to each cathode current collector 20 through a pressure-sensitive adhesive 13, and each anode active material layer 23 adheres to each anode current collector 24 through the pressure-sensitive adhesive 13. Each cathode current collector 20 or anode current collector 24 is shared by the adjacent battery units 50.

The battery unit laminate 300 shown in FIG. 3 is an all-solid-state battery comprising the three battery units 50. However, the number of the battery units 50 of the battery unit laminate 300 is not particularly limited. For example, it may be two or more and 50 or less.

As needed, the all-solid-state battery comprises an outer casing for housing the cathode, the anode and the solid electrolyte layer.

The form of the outer casing is not particularly limited. As the form, examples include, but are not limited to, a laminate form.

The material for the outer casing is not particularly limited, as long as it is a material that is stable in electrolytes. As the material, examples include, but are not limited to, resins such as polypropylene, polyethylene and acrylic resin.

As the all-solid-state battery, examples include, but are not limited to, an all-solid-state lithium battery in which a lithium metal deposition-dissolution reaction is used as an anode reaction, an all-solid-state lithium ion battery in which lithium ions transfer between the cathode and the anode, an all-solid-state sodium battery, an all-solid-state magnesium battery and an all-solid-state calcium battery. The all-solid-state battery may be the all-solid-state lithium ion battery. Also, the all-solid-state battery may be a primary or secondary battery.

As the form of the all-solid-state battery, examples include, but are not limited to, a coin form, a laminate form, a cylindrical form and a square form.

Pressure is applied to the all-solid-state battery during the battery is in use. The pressure may be 1 MPa or more and 45 MPa or less, for example. Pressure is also applied to the all-solid-state battery during the battery is not in use. The pressure may be 0 MPa or more and 1 MPa or less, for example.

As the method for pressurizing the all-solid-state battery, examples include, but are not limited to, mechanical pressurization and gas pressurization.

As the mechanical pressurization, examples include, but are not limited to, pressurizing the all-solid-state battery in the laminating direction through a ball screw by driving a motor, and pressurizing the all-solid-state battery in the laminating direction through oil pressure by driving a motor. In the mechanical pressurization, the all-solid-state battery is pressurized or depressurized to a given pressure, and then the operating part of the machine is fixed by a mechanical stopper, whereby energy consumption accompanied with the driving of the motor is minimized.

As the gas pressurization, examples include, but are not limited to, pressurizing the all-solid-state battery through pressurized gas supplied from an installed gas cylinder.

The all-solid-state battery of the disclosed embodiments is used as a battery source installed in a vehicle, a battery source for driving portable electronic devices, etc. However, the applications of all-solid-state battery of the disclosed embodiments are not limited to them.

Vehicles to which the all-solid-state battery of the disclosed embodiments is applicable, are not limited to electric vehicles which are equipped with a battery and which are not equipped with an engine. They also include hybrid electric vehicles equipped with both a battery and an engine.

### REFERENCE SIGNS LIST

10. Current collector

11. Active material layer

12. Electrolyte layer

13. Pressure-sensitive adhesive

20. Cathode current collector

21. Cathode active material layer

22. Solid electrolyte layer

23. Anode active material layer

24. Anode current collector

40. Cathode

41. Anode

50. Battery unit

100. Laminate

200. Battery unit

300. Battery unit laminate

1. A laminate comprising a current collector, an active material layer and an electrolyte layer in this order,
wherein the current collector and the active material layer adhere to each other in a peelable manner, through a pressure-sensitive adhesive that shows plasticity at normal temperature (15° C. to 25° C.)
